(19) United States
(12) Patent Application Publication
(10) Pub. No.: US 2015/0364932 A1
(43) Pub. Date: Dec. 17, 2015

(54) WIRELESS POWER TRANSFER SYSTEM AND WIRELESS POWER TRANSMITTER

(71) Applicant: SHOWA DENKO K.K., Tokyo (JP)

(72) Inventors: Yasuaki TAMINO, Tokyo (JP); Koji TOKITA, Tokyo (JP); Ryuichi MITSUMOTO, Tokyo (JP); Hiroshi KONUMA, Tokyo (JP); Ayako NISHIOKA, Tokyo (JP); Mitsuhiro IMAIZUMI, Tokyo (JP)

(21) Appl. No.: 14/834,570

(22) Filed: Aug. 25, 2015

Related U.S. Application Data
(63) Continuation of application No. PCT/JP2014/056176, filed on Mar. 10, 2014.

(30) Foreign Application Priority Data
Mar. 13, 2013 (JP) 2013-050617

(51) Int. Cl. H02J 5/00

(52) U.S. Cl. CPC H02J 5/005

(57) ABSTRACT

A wireless power transfer system includes a power transmitter configured to wirelessly transfer alternating-current power components of different frequencies simultaneously, the different frequencies including at least a first frequency and a second frequency, and a power receiver having a rectifier circuit configured to convert the alternating-current power components to a direct-current power component, wherein the first frequency is 0.5 MHz to 10 GHz, and the second frequency is 10 Hz to 300 kHz lower than the first frequency.

### CROSS REFERENCE

This application is a continuation application filed under 35 U.S.C. 111(a) and claims benefit under 35 U.S.C. 120 and 365(c) of PCT International Application No. PCT/JP2014/056176 filed on Mar. 10, 2014 and designating the United States, which International Application claims the priority of Japanese Patent Application No. 2013-050617 filed Mar. 13, 2013, both applications being incorporated herein by reference in its entirety.

### FIELD OF THE INVENTION

The present invention relates to a wireless power transfer system and a wireless power transmitter to transfer power to a wireless power receiver.

### BACKGROUND ART

In recent years studies have been actively made on wireless power transfer or wireless charging systems for charging electric vehicles, mobile devices, flat-panel TV sets, etc., without using solid wires or cables. Especially, wireless charging making use of electric field coupling (also called capacitive coupling) is attracting attention, which technique allows a battery of a consuming device to be charged without physical connection between the electrodes of a power transmitter and a power receiver. See, for example, Japanese Laid-open Patent Publication Nos. 2010-148287 and 2012-034447. Wireless power transfer using electromagnetic induction or magnetic resonance is also known, in addition to the electric field coupling scheme. Using a higher frequency band when performing wireless power transfer is advantageous because high-power transmission is achieved even if the coil turns or the permittivity of the medium existing between electrodes is small.

In wireless power transfer, alternate current (AC) has to be converted to direct current (DC) at the power receiver side. At present, a satisfactory mechanism for rectifying a high frequency current has not been realized. The higher the frequency, the more energy to be lost, and the electric power efficiency in AC-to-DC conversion falls. For example, when using a diode as a rectifier, a portion of the high frequency current passes through without being rectified, depending on the parasitic capacitance (10 pF to 100 pF) generated in the depletion layer between the anode and the cathode of the diode. The alternating current (or power) having passed through the diode is consumed in a smoothing capacitor, and accordingly, the power transfer efficiency is degraded. It may be conceived to increase the high-frequency output level at the power transmitter side to achieve high power transfer. However, as the high-frequency output level increases, the loss in the rectifier also increases and the electric power efficiency cannot be improved. Besides, the capacitor may be destroyed due to the increased high-frequency output level.

### SUMMARY

There is a demand for a structure and a technique that can improve electric power efficiency in high-frequency wireless power transfer.

It is an objective of the invention to provide a wireless power transfer system and a wireless power transmitter that can improve electric power efficiency using a simple structure.

To achieve the objective, at least two alternating-current power components of different frequencies are transferred simultaneously, whereby the electric power efficiency in AC-to-DC conversion is improved at a power receiver side.

In one aspect of the invention, a wireless power transfer system includes

a power transmitter configured to wirelessly transfer alternating-current power components of a first frequency and a second frequency simultaneously, and

a power receiver having a rectifier circuit configured to convert the alternating-current power components to a direct-current power component,

wherein the first frequency is 0.5 MHz to 10 GHz, and the second frequency is 10 Hz to 300 kHz lower than the first frequency.

In a preferred example, the alternating-current power components with the first frequency and the second frequency may be superimposed to produce a mixed wave in the power transmitter, and the mixed wave may be transferred wirelessly to the power receiver.

### BRIEF DESCRIPTION OF THE DRAWINGS

FIG. 1 is a schematic block diagram of a wireless power transfer system according to the embodiment of the invention;

FIG. 2 is a diagram illustrating an exemplified structure of a wireless power transfer system according to the embodiment of the invention;

FIG. 3 is a chart illustrating an alternating-current power transfer efficiency of two mixed waves with the first and the second frequencies superimposed with each other, compared with that of a wave with the first frequency component only;

FIG. 4 illustrates the first modification of the wireless power transfer system according to the embodiment, in which a resonant circuit is inserted in the power receiver;

FIG. 5 illustrates the second modification of the wireless power transfer system according to the embodiment, which system is applied to an electromagnetic induction scheme and a magnetic resonance scheme;

FIG. 6 illustrates the third modification of the wireless power transfer system of an electric field coupling scheme according to the embodiment, in which a parallel-resonant circuit is inserted in the power transmitter; and

FIG. 7 illustrates the fourth modification of the wireless power transfer system according to the embodiment, in which parallel-resonant circuits are inserted in the power transmitter and the power receiver, respectively.

### DESCRIPTION OF EMBODIMENTS

The embodiment of the invention is explained below with reference to the drawings. In the embodiment, a waveform generator 21 is used as an alternating-current (AC) power source to improve the efficiency for high-frequency electric power with a simple structure.

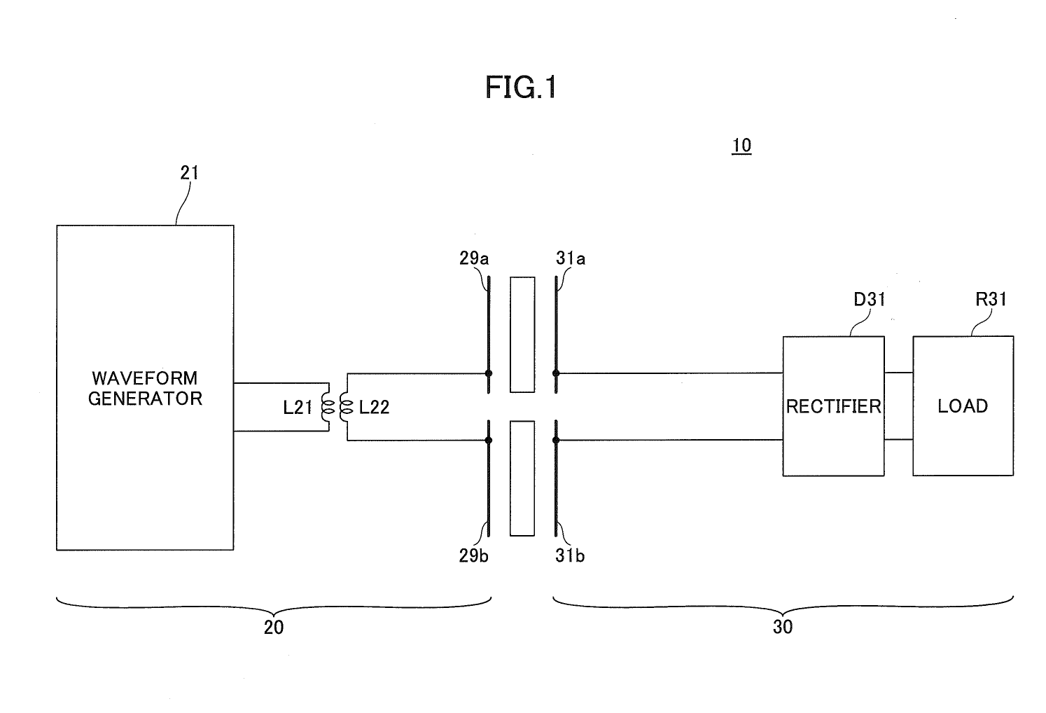

FIG. 1 is a schematic block diagram of a wireless power transfer system 10 according to an embodiment of the invention. The wireless power transfer system 10 includes a wireless power transmitter (hereinafter referred to simply as “power transmitter”) 20 and a wireless power receiver (hereinafter referred to simply as “power receiver”) 30. The wireless power transfer system 10 employs, for example, an electric field coupling scheme. The power transmitter 20 has power transmitting electrodes 29a and 29b, and the power receiver 30 has power receiving electrodes 31a and 31b. The power transmitting electrodes 29a and 29b and the power receiving electrodes 31a and 31b may be plate electrodes with a desired thickness formed of any suitable material such as a metal, a metal oxide, or carbon. The power transmitting electrodes 29a and 29b serve as contactless power transmission terminals. In operations, the power transmitting electrode 29a and the power receiving electrode 31a face each other, while the power transmitting electrode 29b and the power receiving electrode 31b face each other. Power is transferred from the power transmitter 20 to the power receiver 30 by means of electric field coupling between the facing electrode pairs.

The power transmitter 20 may be a stationary apparatus, and the power receiver 30 may be a mobile object. When bringing the power receiving electrodes 31a and 31b of the power receiver 30 face to face with the power transmitting electrodes 29a and 29b of the power transmitter 20 via an arbitrary medium (such as the air, a resin sheet, a resin panel, etc.), wireless power transfer from the power transmitter 20 to the power receiver 30 is carried out.

The power transmitter 20 also has a waveform generator 21 serving as an AC power source, a first coil L21, and a second coil L22 in addition to the power transmitting electrodes 29a and 29b.

The power receiver 30 has a rectifier device D31 and a load R31. The rectifier device D31 may be a bridge rectifier circuit using diodes or a synchronous rectifier circuit using MOSFETs.

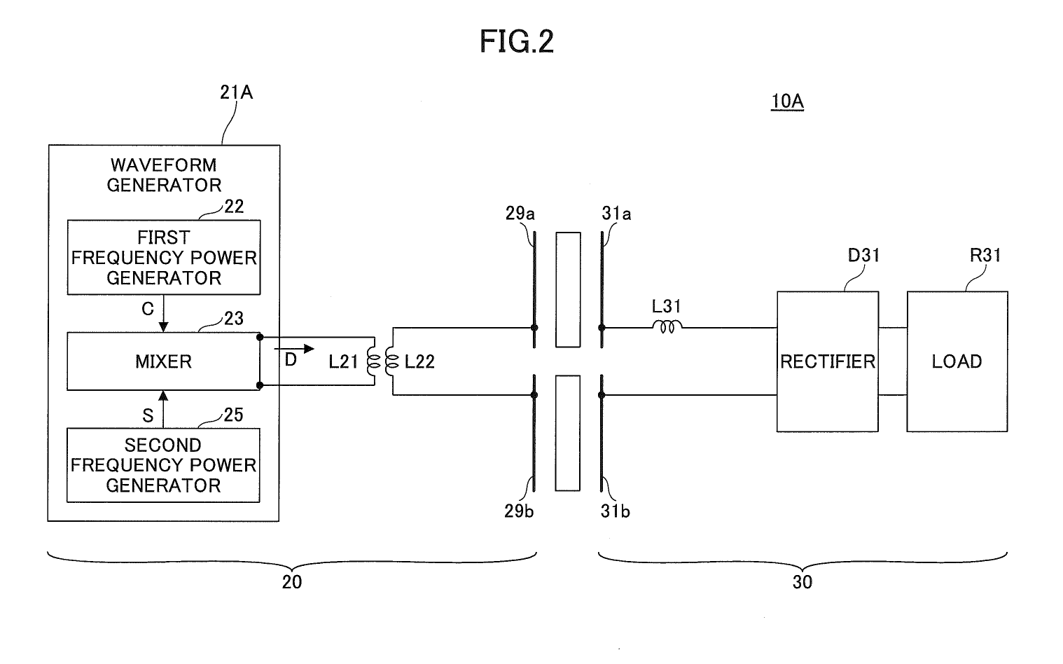

FIG. 2 is a schematic diagram illustrating a wireless power transfer system 10A according to an embodiment of the invention. The same elements or parts as those in FIG. 1 are denoted by the same symbols and redundant explanation is omitted. The waveform generator 21A has a first frequency power generator 22, a second frequency power generator 25, and a mixer 23.

The first frequency power generator 22 generates AC power at the first frequency, which frequency is 0.5 MHz to 10 GHz, preferably from 1 MHz to 30 MHz, and more preferably from 2 MHz to 15 MHz. If the first frequency is less than 0.5 MHz, it is unnecessary to produce a mixed wave because the efficiency of the rectifier device (e.g., the rectifier diode) is not so bad. If the first frequency is higher than 10 GHz, effective improvement in the electric power efficiency is not expected.

The second frequency power generator 25 generates AC power at the second frequency, which frequency is lower than the first frequency by 10 Hz to 300 kHz, preferably by 20 Hz to 150 kHz, and more preferably by 40 Hz to 100 KHz. If the difference between the first frequency and the second frequency is less than 10 Hz, the electric power efficiency is significantly degraded during wireless power transfer via a dielectric medium. If the difference between the first and the second frequencies is greater than 300 kHz, the advantageous effect of the mixed wave is less likely to be seen. In the embodiment, the mixed wave is used to improve the electric power efficiency during the wireless power transfer process.

The power levels of the first frequency AC power and the second frequency AC power are preferably similar to each other as much as possible. A certain degree of difference between the first frequency and the second frequency AC power levels may be acceptable. The advantageous effect of improving the electric power efficiency is still achieved unless the difference exceeds twice the power level of the lower one.

The mixer 23 superimposes the first frequency AC power C generated at the first frequency power generator 22 and the second frequency AC power S generated at the second frequency power generator 25, and outputs a mixed wave D. When the first frequency AC power C and the second frequency AC power S are input to the mixer 23, an amplitude-modulated wave with a beat frequency corresponding to a frequency difference between the two AC power components is produced. The amplitude-modulated wave is output as the mixed wave D from the mixer 23. The mixed wave D is also the output of the waveform generator 21A.

The electric power of the mixed wave D is supplied as an alternating current via the first coil L21 and the second coil L22, to the power transmitting electrodes 29a and 29b.

The power receiver 30 has a coil L31, a rectifier device (such as a rectifier diode) D31, and a load R31, in addition to the electrodes 31a and 31b. By bringing the electrodes 31a and 31b face to face with the electrodes 29a and 29b of the power transmitter 20, the electric field is coupled between the electrodes 29a and 31a and between the electrodes 29b and 31b. As a result, an alternating current is inducted in the power receiver 30.

The coil L31 serves as an antireflection filter to prevent the power transferred to the power receiver 30 from being reflected to the power transmitter 20. The antireflection filter is not limited to the coil L31. A capacitor may be used as the antireflection filter in place of the coil L31.

The AC power having passed through the coil L31 is rectified at a rectifier device (such as a rectifier diode) D31. In general, during rectification using a rectifier diode, the electric power efficiency is likely to degrade especially at a high frequency band. The configuration of the embodiment can improve the electric power efficiency by using a mixed wave even if a rectifier diode is used for rectification.

The direct current rectified by the rectifier device D31 is supplied to the load R31.

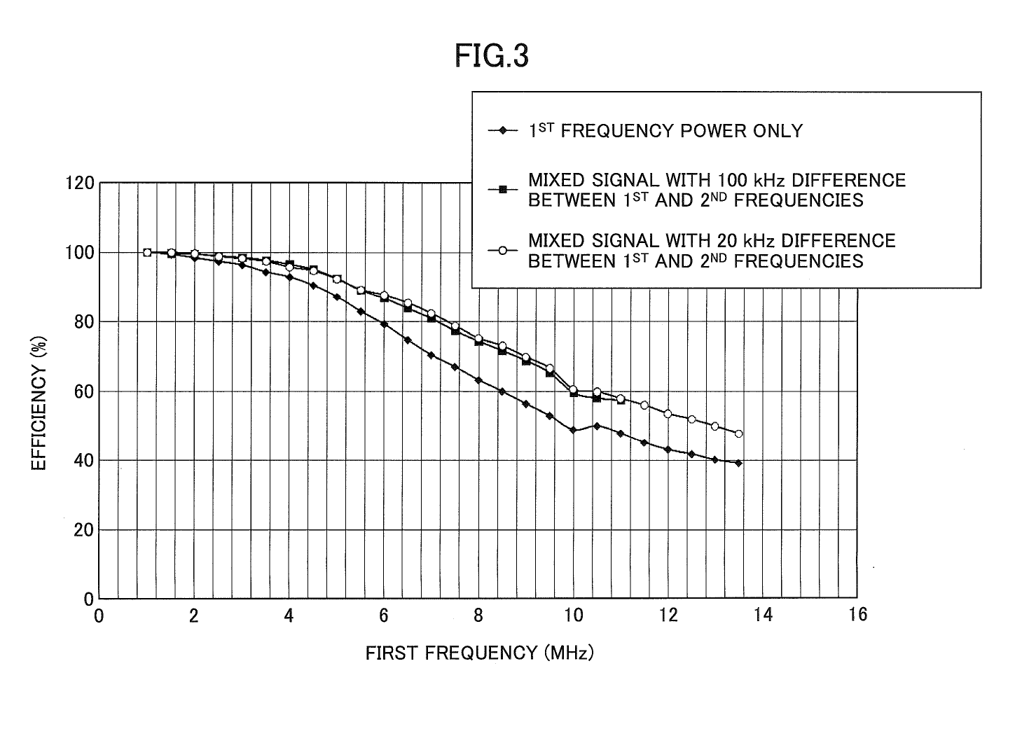

FIG. 3 is a chart illustrating the advantageous effect of improvement of the electric power efficiency by the wireless power transfer system 10A. The electric power efficiency achieved by supplying a mixed wave of a first frequency component and a second frequency component which is 20 kHz lower than the first frequency, as well as the electric power efficiency achieved by supplying a mixed wave of a first frequency component and a second frequency component which is 100 kHz lower than the first frequency, are plotted as a function of the first frequency, compared with that of a single frequency component (using only the first frequency). The electric power efficiency achieved by the first frequency of 1 MHz is set to the 100% efficiency, and then the first frequency is increased. Changes in the electric power efficiency according to the increase in the first frequency are illustrated. The electric power efficiency is estimated by measuring the received power level at each value of the first frequency and dividing the measured power level by the reference power level received at 1 MHz of the first frequency. As the first frequency is increased from 1 MHz to 2 MHz, each of the electric power efficiencies of the mixed wave is well maintained, compared with the first-frequency-only wave. The efficiency keeping effect of the mixed waves becomes more apparent above 2 MHz, and it becomes more conspicuous above 4 MHz. This effect is maintained even at higher frequency.

By applying the waveform generator 21 of the embodiment to the power transmitter of a wireless power transfer system, degradation in the electric power efficiency can be prevented across a wide frequency band.

In the foregoing embodiment, the AC power levels of the first and the second frequencies are adjusted so as to be equal to each other. This applies to other modifications of the invention unless otherwise noted.

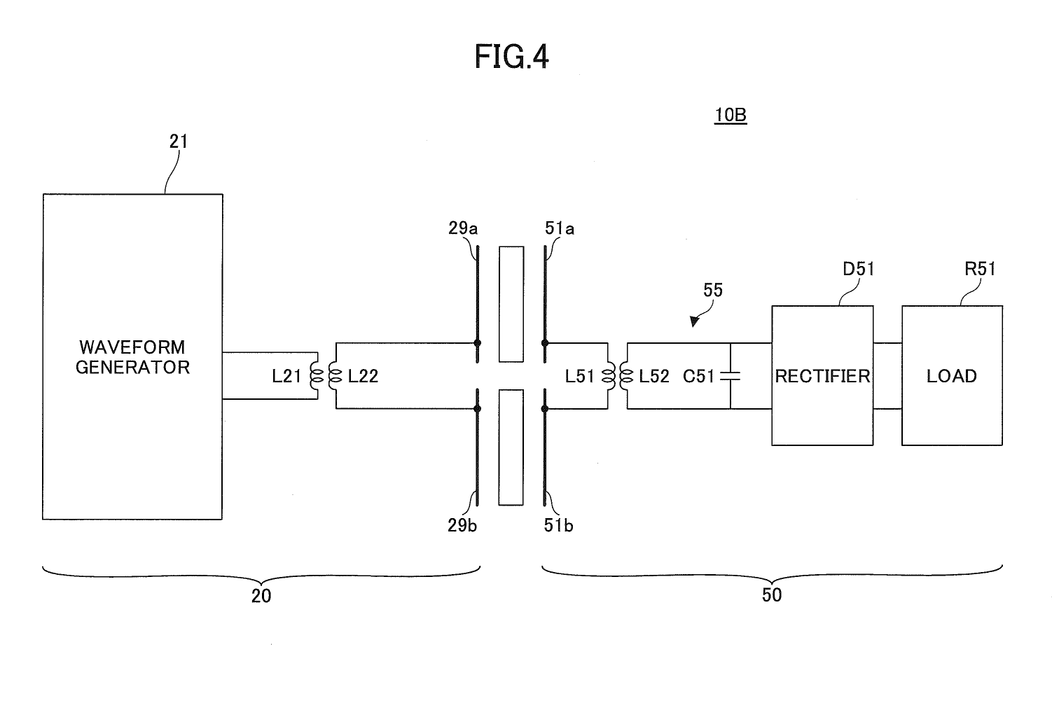

FIG. 4 is a schematic diagram of a wireless power transfer system 10B, which system is illustrated as the first modification of the invention. The wireless power transfer system 10B includes a power transmitter 20 and a power receiver 50. The wireless power transfer system 10B employs an electric field coupling scheme, as in the wireless power transfer system 10A of FIG. 2. A parallel-resonant circuit 55 is inserted in the power receiver 50. The parallel-resonant circuit 55 has a coil L52 and a capacitor C51 connected in parallel.

In the power transmitter 20, a waveform generator 21 is used as an AC power source. The waveform generator 21 may have the same structure as the waveform generator 21A of FIG. 2. The mixed wave is supplied as an alternating current via the first coil L21 and the second coil L22 to the power transmitting electrodes 29a and 29b. Making use of electric field coupling between the power transmitting electrode 29a and the power receiving electrode 51a, and between the power transmitting electrode 29b and the power receiving electrode 51b, AC power is transferred to the power receiver 50. An alternating current is induced in the parallel-resonant circuit 55 due to electromagnetic induction between the coil L51 and the coil L52 of the parallel-resonant circuit 55. With this configuration, even if the coupling capacitance between the facing electrodes changes, the frequency of the parallel-resonant circuit 55 is less affected by the change. Besides, by inserting the parallel-resonant circuit 55, the resonance peak with respect to the power transferred to the power receiver 50 becomes sharp. Accordingly, the AC power transferred from the power transmitter 20 can be supplied efficiently to the rectifier device (such as a rectifier diode) D51.

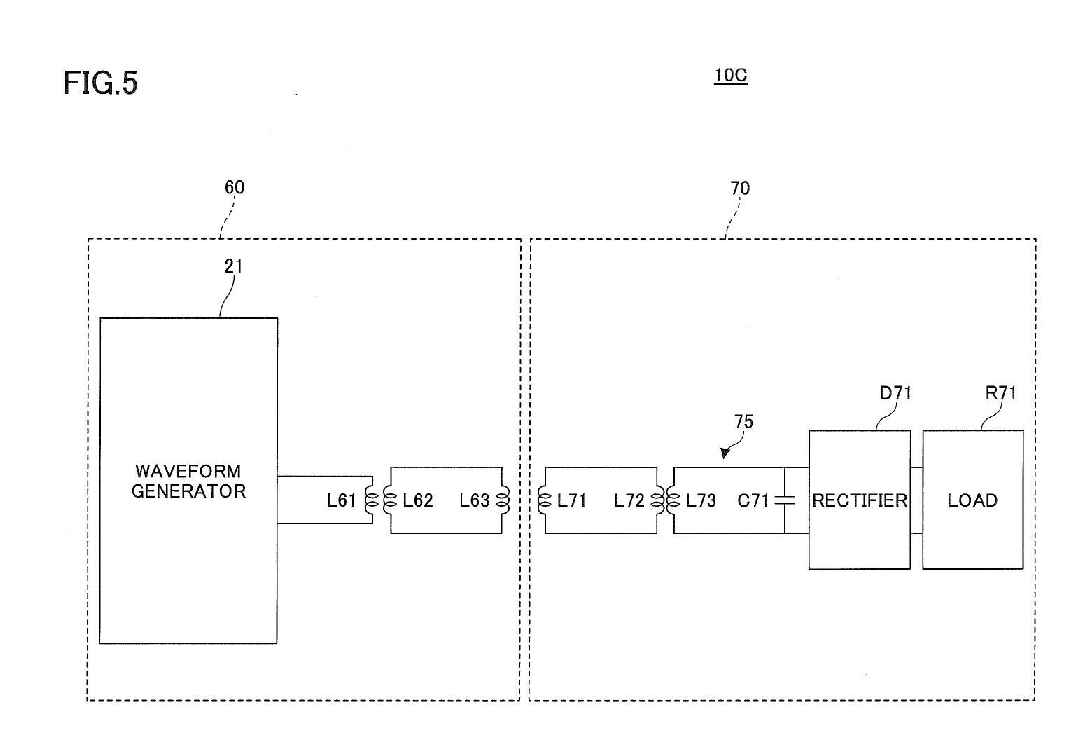

FIG. 5 is a schematic diagram of a wireless power transfer system 10C, which system is illustrated as the second modification of the invention. The wireless power transfer system 10C employs an electromagnetic induction scheme or a magnetic field resonance scheme, and it includes a power transmitter 60 and a power receiver 70.

The power transmitter 60 has a waveform generator 21, a first coil L61, a second coil L62, and a third coil L63. The third coil L63 serves as a contactless power transmission terminal. The AC power of the mixed wave produced by the waveform generator 21 is supplied through the first coil L61 and the second coil L62 to the third coil L63, and an alternating current flows in the third coil L63. The magnetic fluxes generated at the third coil L63 penetrate through the coil L71 of the power receiver 70, and electromotive force is generated (electromagnetic induction).

When the third coil L63 of the power transmitter 60 and the coil L71 of the power receiver 70 have the same resonant frequency, the magnetic field resonance scheme applies. In this case, the energy (that is, the oscillation of the magnetic field) of the mixed wave generated by the waveform generator 21 is transferred to the coil L71 of the power receiver 70 by the magnetic field resonance. Employing the magnetic field resonance scheme is advantageous from the viewpoint of less degradation in the electric power efficiency with respect to positional offset between the power transmitter 60 and the power receiver 70.

The power receiver 70 has an LC resonant circuit 75. The alternating current flowing via the coil L72 in the LC resonant circuit 75 is rectified by a rectifier device (such as a rectifier diode) D71, and is consumed at the load R71. This configuration also allows the mixed wave alternating current to be rectified efficiently at the rectifier device D71.

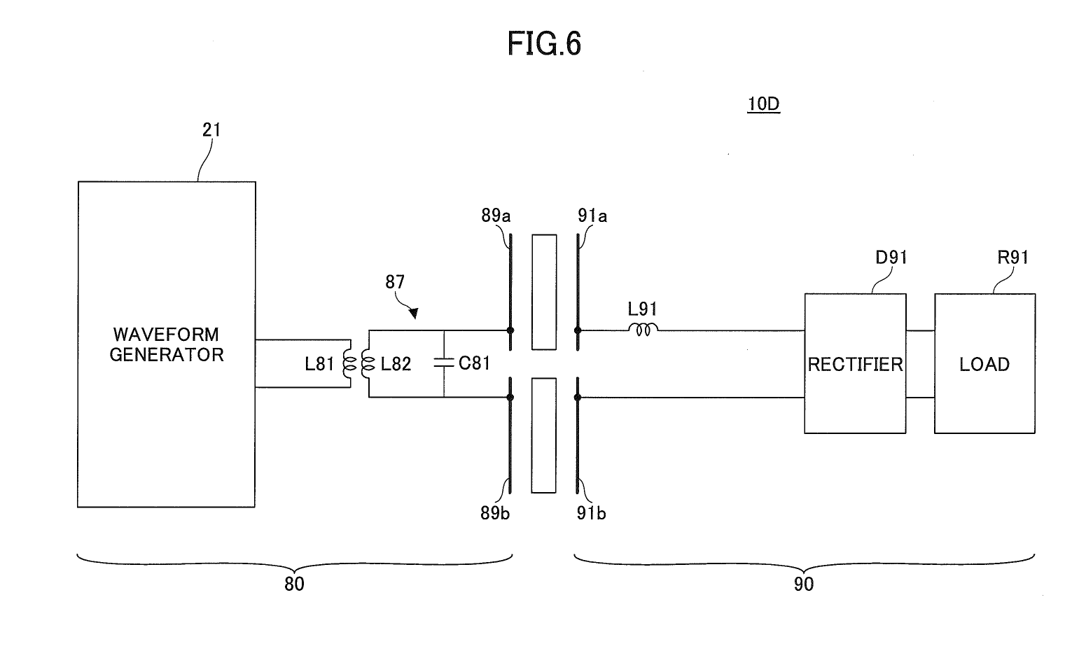

FIG. 6 is a schematic diagram of a wireless power transfer system 10D, which system is illustrated as the third modification of the invention. The wireless power transfer system 10D employs an electric field coupling scheme, and it includes a power transmitter 80 and a power receiver 90. In the wireless power transfer system 10D, the power transmitter 80 has an LC resonant circuit 87, while the LC resonant circuit is omitted from the power receiver 90.

The power transmitter 80 has a waveform generator 21, a coil L81, an LC resonant circuit 87, and power transmitting electrodes 89a and 89b. The LC resonant circuit 87 has a coil L82 and a capacitor C81 connected in parallel. The AC power of the mixed wave generated by the waveform generator 21 is transferred via the coil L81 to the LC resonant circuit 87, and supplied as an alternating current to the power transmitting electrodes 89a and 89b. The AC power of the mixed wave is transferred to the power receiver 90 by means of the electric field coupling between the power transmitting electrode 89a and the power receiving electrode 91a, and between the power transmitting electrode 89b and the power receiving electrode 91b. The AC power of the mixed wave supplied via the coil L91 to the rectifier device (such as a rectifier diode) D91 and rectified. The rectified current is consumed by the load R91. The coil L91 serves as an antireflection filter; however, the invention is not limited to this example. A capacitor may be used as the antireflection filter.

By transferring power or energy in the form of a mixed wave, loss in the rectifier device D91 of the power receiver 90 can be reduced. By providing the LC resonant circuit 87 only in the power transmitter 80, tuning is facilitated and the number of components used in the overall system is reduced. In addition, the power receiver 90 can be made compact.

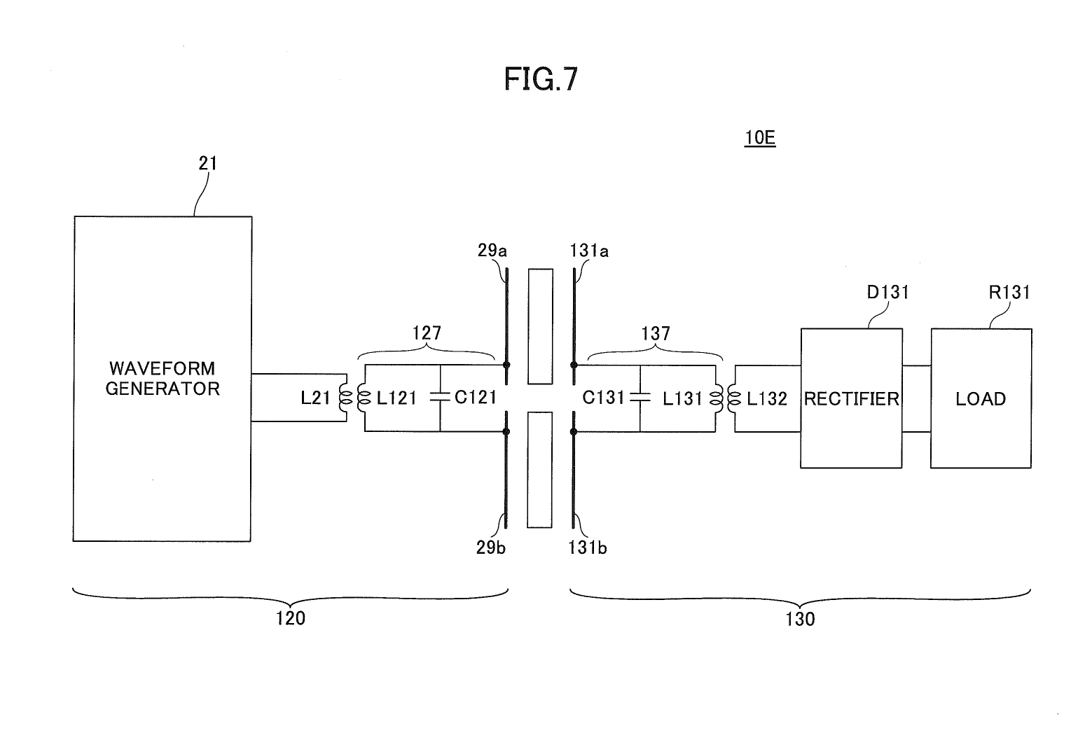

FIG. 7 is a schematic diagram of a wireless power transfer system 10E, which system is illustrated as the fourth modification of the invention. The wireless power transfer system 10E employs an electric field coupling scheme, and it includes a power transmitter 120 and a power receiver 130. In the wireless power transfer system 10E, each of the power transmitter 120 and the power receiver 130 has a parallel-resonant circuit.

The power transmitter 120 has a waveform generator 21, a coil L21, an LC resonant circuit 127, and power transmitting electrodes 29a and 29b. The power receiver 130 has power receiving electrodes 131a and 131b, an LC resonant circuit 137, a coil L132, a rectifier device (such as a rectifier diode) D131, and a load R131.

The waveform generator 21 may have the same structure as that illustrated in FIG. 2. The transmitter-side LC resonant circuit 127 and the receiver-side LC resonant circuit 137 are coupled by the electric field between the electrodes 29a and 131a and between the electrodes 29b and 131b. The coupling capacities between the facing electrode pairs are independent from the LC resonant circuits 127 and 137. Accordingly, when the coupling capacities are small compared with the capacitances C121 and C131 of the LC resonant circuits 127 and 137, the frequencies of the LC resonant circuits 127 and 137 are less influenced by change in the coupling capacitance.

The AC power of the mixed wave transferred to the power receiver 130 is supplied as an alternating current via the coil L132 to the rectifier device D131, and rectified. The rectified current is supplied to the load R131. Using the mixed wave, degradation of the rectification efficiency can be reduced and the electric power efficiency is improved.

As has been explained above, the wireless power transfer system of the invention is applicable to any of the electric field coupling scheme, the electromagnetic induction scheme, the magnetic field resonance scheme, and a radio wave charging scheme. The wireless power transfer system of the invention is also applicable regardless of whether a resonant circuit is used, or regardless of series resonance or parallel resonance. The technique of the embodiments can improve the electric power efficiency in wireless power transfer using an arbitrary scheme or configuration.

What is claimed is:

1. A wireless power transfer system comprising:
a power transmitter configured to wirelessly transfer alternating-current power components of different frequencies simultaneously, the different frequencies including at least a first frequency and a second frequency, and
a power receiver having a rectifier circuit configured to convert the alternating-current power components to a direct-current power component,
wherein the first frequency is 0.5 MHz to 10 GHz, and the second frequency is 10 Hz to 300 kHz lower than the first frequency.

2. The wireless power transfer system according to claim 1, wherein the power transmitter is configured to generate a mixed wave by superimposing the alternating-current power components of the first frequency and the second frequency and supply the mixed wave as an electric power to the power receiver.

3. The wireless power transfer system according to claim 1, wherein power levels of the first frequency power component and the second frequency power component are equal to each other.

4. The wireless power transfer system according to claim 1,
wherein the power transmitter has a power transmitting electrode, the power receiver has a power receiving electrode, and a dielectric substance exists between the power transmitting electrode and the power receiving electrode, and
wherein an electric power is transferred making use of electric field coupling.

5. The wireless power transfer system according to claim 1,
wherein the power transmitter has a power transmitting coil, and the power receiver has a power receiving coil, and
wherein an electric power is transferred making use of electromagnetic induction or magnetic field resonance.

6. The wireless power transfer system according to claim 1,
wherein at least one of the power transmitter and the power receiver has a resonant circuit power component and a second frequency power component

7. A wireless power transmitter comprising:
a waveform generator configured to generate an alternating current electric power of a mixed wave containing at least two different frequencies; and
a wireless power transmitting terminal configured to wirelessly transmit the alternating current electric power of the mixed wave,
wherein the waveform generator has
a first frequency power generator configured to produce a first alternating current power,
a second frequency power generator configured to produce a second frequency alternating current power, the second frequency being different from the first frequency, and
a mixer configured to combine the first frequency alternating power and the second frequency alternating power and produce a mixed wave, and
wherein the first frequency is 0.5 MHz to 10 GHz, and the second frequency is 10 Hz to 300 kHz lower than the first frequency.

8. A wireless power transfer method comprising:
at a power transmitter, generating a mixed wave containing at least a first alternating current power component of a first frequency and a second alternating current component of a second frequency;
wirelessly transferring the mixed wave from the power transmitter to a power receiver; and
at the power receiver, rectifying the mixed wave to acquire a direct current electric power,
wherein the first frequency is 0.5 MHz to 10 GHz, and the second frequency is 10 Hz to 300 kHz lower than the first frequency.
